(19) United States
(12) Patent Application Publication
(10) Pub. No.: US 2022/0411894 A1
(43) Pub. Date: Dec. 29, 2022

(54) METHOD OF SEPARATING ONE OR MORE ELEMENTS FROM AN ALLOY

(71) Applicant: Iowa State University Research Foundation, Inc., Ames, IA (US)

(72) Inventors: Martin Thuo, Ames, IA (US); Thomas Ward, III, Des Moines, IA (US); Andrew Martin, Ames, IA (US)

(21) Appl. No.: 17/845,712

(22) Filed: Jun. 21, 2022

Related U.S. Application Data
(60) Provisional application No. 63/214,383, filed on Jun. 24, 2021.

(51) Int. Cl. C22B 9/16

(52) U.S. Cl. CPC C22B 9/16

(57) ABSTRACT

A method of separating one or more elements from an alloy includes subjecting a metal alloy to a stimulus to form an enriched material including the one or more elements and to form a depleted material. The enriched material is enriched in the one or more elements compared to the alloy and the depleted material is depleted in the one or more elements compared to the alloy. The method also includes removing the enriched material and the depleted material from one another.

### CROSS-REFERENCE TO RELATED APPLICATION

This application claims the benefit of priority to U.S. Provisional Patent Application Ser. No. 63/214,383 filed Jun. 24, 2021, the disclosure of which is incorporated herein in its entirety by reference.

### BACKGROUND

Metallic alloys containing one or more valuable elements are common. However, separation and purification of one or more of the elements in the alloy can be difficult or impossible. This can make recovery of certain elements from alloys in discarded materials impractical despite the high value and limited supply of certain elements.

Advances in microelectronic devices has hinged on unique properties of critical materials albeit each geared towards a specific function in these highly complex systems. Critical materials include rare-earth elements, platinum-group elements, and other elements such as antimony, beryllium, cesium, cobalt, gallium, germanium, indium, lithium, niobium, tantalum, tellurium, and tungsten. Challenges in continued improvements, however, have been exacerbated by a quasi-monopolistic supply coupled with limits to availability of high concentration mineable ore(s). Recycling and upcycling are, therefore, a critical pathway to sustainability albeit most recycling approaches rely on either wasteful chemical leaching or smelting. These methods are based on Gibbsian thermodynamics and are therefore costly, inefficient, and energy intensive. The classical nature of current methods renders them untenable in recovery of low concentration species. These methods are also not selective and cannot, therefore, be used to target a low concentration, but high value, component of an alloy or mixed material system.

### SUMMARY OF THE INVENTION

The present invention provides a method of separating one or more elements from an alloy. The method includes subjecting a metal alloy to a stimulus to form an enriched material including the one or more elements and to form a depleted material. The enriched material is enriched in the one or more elements compared to the alloy and the depleted material is depleted in the one or more elements compared to the alloy. The method also includes removing the enriched material and the depleted material from one another.

The present invention provides a method of separating one or more elements from an alloy. The method includes subjecting a metal alloy to a stimulus including shearing a mixture including the alloy in a solvent to form an enriched material including the one or more elements and to form a depleted material. The enriched material is enriched in the one or more elements compared to the alloy and the depleted material is depleted in the one or more elements compared to the alloy. The method optionally includes solidifying the enriched material and/or the depleted material. The method also includes removing the enriched material and the depleted material from one another. The one or more elements include Al, Fe, Cu, Zn, Ga, Ge, Ag, Cd, In, Sn, Sb, Te, Ho, Au, Pb, Bi, Nd, Fe, Sm, B, Er, Ni, Mn, Dy, Pr, W, Ti, Mg, Li, Co, or a combination thereof.

The present invention provides a method of separating one or more elements from an alloy. The method includes subjecting a metal alloy to a stimulus including heating to form a solidified enriched material including the one or more elements and to form a solidified depleted material. The enriched material is enriched in the one or more elements compared to the alloy and the depleted material is depleted in the one or more elements compared to the alloy. The method also includes removing the solidified enriched material and the solidified depleted material from one another. The one or more elements include Al, Fe, Cu, Zn, Ga, Ge, Ag, Cd, In, Sn, Sb, Te, Ho, Au, Pb, Bi, Nd, Fe, Sm, B, Er, Ni, Mn, Dy, Pr, W, Ti, Mg, Li, Co, or a combination thereof.

The present invention provides a method of separating one or more elements from an alloy. The method includes subjecting a metal alloy to a stimulus including laser irradiation to form a solidified enriched material including the one or more elements and to form a solidified depleted material. The enriched material is enriched in the one or more elements compared to the alloy and the depleted material is depleted in the one or more elements compared to the alloy. The method also includes removing the solidified enriched material and the solidified depleted material from one another. The one or more elements include Al, Fe, Cu, Zn, Ga, Ge, Ag, Cd, In, Sn, Sb, Te, Ho, Au, Pb, Bi, Nd, Fe, Sm, B, Er, Ni, Mn, Dy, Pr, W, Ti, Mg, Li, Co, or a combination thereof.

Various aspects of the method of the present invention have certain advantages over other separation methods. For example, in various aspects, the method of the present invention can be used to separate alloys that are difficult to separate using other methods. In various aspects, the method of the present invention can be used to separate valuable metallic components of metal alloys, such as critical elements. In various aspects, the method of the present invention can be used to up-cycle a waste stream, such as by selectively removing all or part of a waste stream and converting it to higher value materials (e.g., nanoparticles).

### BRIEF DESCRIPTION OF THE FIGURES

The patent or application file contains at least one drawing executed in color. Copies of this patent or patent application publication with color drawing(s) will be provided by the Office upon request and payment of the necessary fee.

The drawings illustrate generally, by way of example, but not by way of limitation, various aspects of the present invention.

FIGS. 1A, 1C, and 1E illustrate schematics of various heat/oxidation-based separations, in accordance with various aspects.

FIGS. 1B, 1D, and 1F illustrate SEM images of particles having been subjected to the heat/oxidation based separation shown in FIGS. 1A, 1C, and 1E, respectively, in accordance with various aspects.

FIGS. 2A-B each illustrate a series of SEM images illustrating focused ion beam (FIB) milling of heat-treated particles indicating the separation of the most reactive elements (darker contrast) and the least reactive component (lighter contrast) within the core of the particle, in accordance with various aspects.

FIG. 3A illustrates an energy dispersive spectroscopy (EDS) map of a thermally treated alloy and shows separation between the most reactive component forming the shell and the least reactive component coming out of the cracks due to thermal expansion-contraction, in accordance with various aspects.

FIG. 3B illustrates an in-situ heated X-ray diffraction (XRD) pattern of a thermally treated alloy displaying periodic growth of specific oxide, followed by crystallization (hence appearance of related x-ray signal) of the least reactive component post heating, in accordance with various aspects.

FIG. 3C illustrates a SEM image of a heat-treated alloy, showing that spallation may occur from excess oxidation, resulting in peeling of the outermost layer, in accordance with various aspects.

FIGS. 4A and 4B illustrate schematics of a laser-based separation process, in accordance with various aspects.

FIG. 5A illustrates a SEM image of a laser treated InBiSn particle, showing the overall area of effect with the exploded particle in the center and the generated plumes in the perimeter (cloudy fuzz-like material), in accordance with various aspects.

FIG. 5B illustrates an energy dispersive spectroscopy (EDS) map of the area of effect shown in FIG. 5A, and a corresponding plot of weight percentage versus distance for each element, indicating the separation of the most laser-reactive element (least reactive with heat) towards the perimeter and the least laser reactive elements in the center, in accordance with various aspects.

FIG. 5C illustrates a transmission electron microscopy (TEM) image of the harvested plume material, indicating crystallinity, in accordance with various aspects.

FIG. 6 illustrates an EDS map of the area of effect after laser-treatment of SAC305 alloy, and a corresponding plot illustrating wt % versus distance from the core for the laser-treated SAC305 alloy, in accordance with various aspects.

FIG. 7A illustrates a SEM image of an untreated Nd/Dy magnet, in accordance with various aspects.

FIGS. 7B-C illustrates EDS maps of the untreated Nd/Dy magnet, with FIG. 7B showing Nd and FIG. 7C showing Dy, in accordance with various aspects.

FIG. 8A illustrates a SEM image of the Nd/Dy magnet after laser-treatment, in accordance with various aspects.

FIGS. 8B-D illustrate EDS maps of the treated Nd/Dy magnet, with FIG. 8B showing Nd, FIG. 8C showing Dy, and with FIG. 8D showing oxygen, in accordance with various aspects.

FIG. 9A illustrates weight percent versus distance from the core for a laser-treated SnInBi alloy, using a 2.7 W blue laser for 30 s, in accordance with various aspects.

FIG. 9B illustrates weight percent versus distance from the core for a laser-treated SnInBi alloy, using a 3.3 W blue laser for 30 s, in accordance with various aspects.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99/0, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

Method of Separating One or More Elements from an Alloy.

The present invention provides a method of separating one or more elements from an alloy. The method includes subjecting a metal alloy to a stimulus to form an enriched material including the one or more elements and to form a depleted material. The enriched material is enriched in the one or more elements compared to the alloy and the depleted material is depleted in the one or more elements compared to the alloy. The method also includes removing the enriched material and the depleted material from one another.

The stimulus can be any suitable stimulus that causes formation of the enriched material and the depleted material from the metal alloy. The stimulus can include shear, laser irradiation, heat, or a combination thereof. The stimulus can include laser irradiation, heat, or a combination thereof. The stimulus can include shearing with sequential or simultaneous laser irradiation, heat, or a combination thereof.

The enriched material and/or the depleted material can be solid materials, liquid materials, or a combination thereof. The metal alloy can include liquid metal alloy, solid metal alloy, or a combination thereof. The stimulus can cause some or all of the metal alloy to change to a liquid state. The enriched material and/or depleted material can solidify prior to the removing of the enriched material and the depleted material from one another, whether the metal alloy includes liquid metal alloy prior to the stimulus or the metal alloy is free of liquid metal alloy prior to the stimulus. The enriched material can be a solidified enriched material. The depleted material can be a solidified depleted material. The method can include solidifying the liquid enriched material and/or liquid depleted material to form the solidified enriched material and/or solidified depleted material. The solidifying can include cooling the enriched material and/or depleted material (e.g., active cooling or passive cooling).

The metal alloy subjected to the stimulus can be subjected to the stimulus alone or can be subjected to the stimulus as a part of other materials. For example, a mixed material, such as electronic waste (e.g., discarded electronic components such as circuit boards, electronic components, and/or integrated circuits) can include the metal alloy during the subjection of the metal alloy to the stimulus. The method can be an efficient and effective way to separate one or more elements from mixed materials such as electronic waste. A polymer composite, ceramic composite, or a combination, can include the metal alloy, and the method can be an efficient and effective way to separate one or more elements from such composites.

The metal alloy can be any suitable metal alloy that forms the enriched and depleted materials upon subjection to the stimulus. The metal alloy can include a liquid metal alloy, or the metal alloy can be substantially free of liquid metal alloy. The metal alloy can include a solid metal alloy, or the metal alloy can be substantially free of solid metal alloy. The metal alloy can include a mixture of liquid metal alloy and solid metal alloy. The metal alloy can be magnetic (e.g., magnetized or quenched), or the metal alloy can be non-magnetic.

In some embodiments, the metal alloy has a uniform composition throughout. In some embodiments, the metal alloy includes a solid metal oxide shell surrounding a core that is a liquid metal core, a solid metal core, or a combination thereof. The solid core can include a metal alloy in a metastable solid state, such as metallic glass. The solid oxide shell can have a diameter of 0.5 nm to 20 microns, or 0.5 microns to 5 microns, or less than or equal to 20 microns and greater than or equal to 0.5 nm, 1, 5, 10, 15, 20, 25, 50, 75, 100, 150, 200, 250, 500, 750 nm, 1 micron, 2, 3, 4, 5, 6, 7, 8, 9, 10, 12, 14, 16, or 18 microns.

The metal alloy can include a liquid metallic core enclosed within a solid oxide shell. The liquid metallic core can be below the melting point thereof at the onset of the application of the stimulus to the metal alloy, or the liquid metallic core can be above the melting point thereof at the onset of the application of the stimulus to the metal alloy.

The metal alloy can include Al, Fe, Cu, Zn, Ga, Ge, Ag, Cd, In, Sn, Sb, Te, Ho, Au, Pb, Bi, Nd, Fe, Sm, B, Er, Ni, Mn, Dy, Pr, W, Ti, Mg, Li, Co, or a combination thereof. The metal alloy includes Bi, In, Sn, Ag, Au, Ga, Nd, B, Er, or a combination thereof. The metal alloy can be a eutectic alloy, or a non-eutectic alloy. The alloy can include Field's metal (e.g., 51% In, 32.5% Bi, and 16.5% Sn w/w). The metal alloy can include In and Sn, such as a eutectic or non-eutectic alloy thereof. The metal alloy can include Bi and Sn, such as a eutectic or non-eutectic alloy thereof. The alloy can include Bi, In, and Sn, such as a eutectic or non-eutectic alloy thereof. The alloy can include Bi, Ga, and In, such as a eutectic or non-eutectic alloy thereof. The alloy can include a solder alloy. The alloy can include Sn, Ag, and Cu, such as a eutectic or non-eutectic alloy thereof.

The enriched material can be enriched in Al, Fe, Cu, Zn, Ga, Ge, Ag, Cd, In, Sn, Sb, Te, Ho, Au, Pb, Bi, Nd, Fe, Sm, B, Er, Ni, Mn, Dy, Pr, W, Ti, Mg, Li, Co, or a combination thereof Δny suitable proportion of the enriched material can be the one or more elements; for example, 50 wt % to 100 wt % of the enriched material can be the one or more elements, or 80 wt % to 100 wt % or 90 wt % to 100 wt %, or less than or equal to 100 wt % and greater than or equal to 50 wt %, 52, 54, 56, 58, 60, 62, 64, 66, 68, 70, 72, 74, 76, 78, 80, 82, 84, 86, 88, 90, 91, 92, 93, 94, 95, 96, 97, 98, 99, 99.5, or 99.9 wt %.

The depleted material can be depleted in Al, Fe, Cu, Zn, Ga, Ge, Ag, Cd, In, Sn, Sb, Te, Ho, Au, Pb, Bi, Nd, Fe, Sm, B, Er, Ni, Mn, Dy, Pr, W, Ti, Mg, Li, Co, or a combination thereof. Any suitable proportion of the depleted material can be the one or more elements; for example, 0 wt % to 50 wt % of the depleted material can be the one or more elements, or 0 wt % to 20 wt %, or 0 wt % to 10 wt %, or less than or equal to 50 wt % and greater than or equal to 0 wt %, 0.1, 0.5, 1, 2, 3, 4, 5, 6, 7, 8, 9, 10, 12, 14, 16, 18, 20, 22, 24, 26, 28, 30, 32, 34, 36, 38, 40, 42, 44, 46, or 48 wt %.

The subjecting of the metal alloy to the stimulus can cause preferential oxidation of elements having the greatest reactivity toward oxidation. For metal alloys including an outer metal oxide shell, subjecting of the alloy to the stimulus can form the enriched material on and/or outside an exterior of the shell. In some embodiments, the enriched material can include a plume of enriched material extending from the shell. Subjecting of the alloy to the stimulus can form the enriched material in an interior of the shell. During the subjecting of the alloy to the stimulus, the shell can grow in size and/or thickness, and the depleted material can include the shell.

The stimulus can include shearing a mixture including the metal alloy in a solvent. The stimulus can also include simultaneously or sequentially stimulating the metal alloy using heating, laser irradiation, or a combination thereof. The stimulus including shearing can be free of stimulating the metal alloy using heating, laser irradiation, or a combination thereof. The shearing can be performed at any suitable shear rate, such as 1 rpm to 100,000 rpm, or 100 rpm to 100,000 rpm, or 500 rpm to 50,000 rpm, or less than or equal to 100,000 rpm and greater than or equal to 1 rpm, 5, 10, 25, 50, 100, 150, 200, 250, 500, 750, 1,000, 2,000, 5,000, 10,000, 20,000, 50,000, or 90,000 rpm. The shearing can be performed for any suitable duration, such as 0.1 min to 1 day, or 1 min to 2 h, or less than or equal to 1 day and greater than or equal to 0.1 min, 0.2, 0.4, 0.6, 0.8, 1, 2, 4, 6, 8, 10, 20, 30, 40, 50 min, 1 h, 2, 3, 4, 5, 6, 8, 10, 12, 14, 16, 18, 20, or 22 h. The shearing can be performed in any suitable solvent, such as an organic solvent, such as an alcohol (e.g., ethanol). The solvent can optionally include an organic acid, such as a C1-C10 carboxylic acid, such as acetic acid, propionic acid, or a combination thereof. The shearing can be performed at room temperature or at any suitable temperature, such as 0° C. to 1000° C., or 20° C. to 500° C., or less than or equal to 1000° C. and greater than or equal to 0° C., 10, 15, 20, 25, 30, 40, 50, 75, 100, 150, 200, 300, 400, 500, 600, 700, 800, or 900° C.

The stimulus can include heating the metal alloy. The heating can include heating to 373 K to 2000 K, 750 K to 1500 K, or less than or equal to 2000 K and greater than or equal to 373 K, 400, 425, 450, 500, 600, 700, 800, 900, 1,000, 1,100, 1,200, 1,300, 1,400, 1,500, 1,600, 1,700, 1,800, or 1,900 K. The heating can be performed for any suitable duration, such as 0.1 min to 1 day, or 1 min to 2 h, or less than or equal to 1 day and greater than or equal to 0.1 min, 0.2, 0.4, 0.6, 0.8, 1, 2, 4, 6, 8, 10, 20, 30, 40, 50 min, 1 h, 2, 3, 4, 5, 6, 8, 10, 12, 14, 16, 18, 20, or 22 h.

The method can include laser irradiating the metal alloy. The laser irradiation can have any suitable power and can be performed for any suitable duration such that the enriched and depleted materials are formed. The method can include laser irradiating the metal alloy using a laser that is tuned to provide the greatest reactivity to the one or more elements in the alloy that the enriched material is enriched in compared to the depleted material. The laser irradiation can include laser irradiating the shell of a core-shell particle including a liquid and/or solid metal alloy core. The laser irradiation can be performed at room temperature or at any suitable temperature, such as 0° C. to 1000° C., or 20° C. to 500° C., or less than or equal to 1000° C. and greater than or equal to 0° C., 10, 15, 20, 25, 30, 40, 50, 75, 100, 150, 200, 300, 400, 500, 600, 700, 800, or 900° C. The laser irradiation can be performed for any suitable duration, such as 0.1 min to 1 day, or 1 min to 2 h, or less than or equal to 1 day and greater than or equal to 0.1 min, 0.2, 0.3, 0.4, 0.5, 0.6, 0.7, 0.8, 0.9, 1, 2, 4, 6, 8, 10, 20, 30, 40, 50 min, 1 h, 2, 3, 4, 5, 6, 8, 10, 12, 14, 16, 18, 20, or 22 h. The laser irradiation can include any suitable power and frequency of laser.

The method includes removing the enriched material from the depleted material, removing the depleted material from the enriched material, or a combination thereof. The removing can be performed in any suitable way such that the enriched material are physically separated from one another. For example, the removing can include suction, blowing, chemical treatment, vibration, electrostatics, sink-float, density differentiation, centrifugal force, magnetic levitation, sonication, or a combination thereof.

### EXAMPLES

Various embodiments of the present invention can be better understood by reference to the following Examples which are offered by way of illustration. The present invention is not limited to the Examples given herein.

### Example 1. Use of Heat to Separate One or More Elements from an Alloy

Example 1 is taken from Martin, A., et al., “Passivation-driven speciation, dealloying and purification”, Materials Horizons, 2021, 8(3), 925-931 (“Martin”), hereby incorporated by reference in its entirety.

### Experimental

Materials: Field's metal (32.5% Bi, 51% In, 16.5% Sn, Tₘ=355 K), Bi—Sn alloy (58% Bi, 42% Sn, Tₘ=411 K) and In—Sn alloy (52% In, 48% Sn, Tₘ=391 K) were purchased from Rotometals inc. Diethylene glycol (99%) was purchased from Alfa Aesar. Ethyl acetate (99.9%), glacial acetic acid (99.7%), trichloroacetic acid (99.8%) was purchased from Fisher Chemical.

Undercooled Liquid Metal Core-Shell Particle Synthesis: Undercooled core-shell metal particles were synthesized using shearing into complex particles (SLICE) method, a previously reported procedure (see, Tevis, I. D, Newcomb, L. B., Thuo, M., Langmuir, 2014, 30(47), 14308-14313, U.S. Pat. Nos. 10,266,925, and 10,293,325, hereby incorporated by reference in its entirety).

SEM Characterization: Metal particles stored in ethyl acetate solution were transferred onto silicon wafer using pipettes and then were characterized by Scanning Electron Microscopy (FEI Quanta 250 FEI-SEM). Samples are mounted on standard SEM mount (Ted Pella Inc.) adhered with copper tape. The SEM was operated under high vacuum at a voltage of 10-15 kV with spot size of 3 at 10 mm working distance. Everhart-Thorley Secondary electron detector and backscatter detector were used to take micrographs at various magnifications. Size measurements for features were done using ImageJ software

Focused Ion Beam (IB)-SM Analysis: The sample was prepared using a FEI Helios NanoLab G3, on a 38-degree back-tilt holder with the sample attached to the back-tilted portion of the stub. Initial machining was carried out at 4 mm working distance (eucentric height) at 30 kV on the Ion column, with a 5 kV finishing step, the machining was performed at zero-tilt, so that the machined surface was 52-degrees with respect to the electron column axis.

TGA Heat Treatment: The particles were heat treated using Thermogravimetric Analyzer (Q50 TGA, TA Instruments). The particles were then drop casted onto undoped silicon wafers that are previously cleaned using ethanol and dried with ultrahigh-purity nitrogen gas. Sample was then placed on a platinum TGA pan. The heat treatment was carried in presence of air, with helium purge gas. Purge gas flow rate was set at 60 ml/min and heating ramp rate at 10° C./min up to 1000° C.

Thermogravimetric Analysis (TGA)-Infrared (IR)-Mass Spectrometry (MS) Analysis: Coupled TGA-IR-MS instrument (Netzsch STA449F1) was used to analyze mass change and evolved gas released during particle's heat treatment. Sample was deposited and dried in an alumina crucible with a matching reference crucible used. Simulated dry air (80% oxygen 20% nitrogen) was used as the purge gas. Sample was then loaded and ran through a heating ramp step at 10° C./min. Obtained raw data was analyzed using Proteus and Opus software.

High-Temperature X-Ray Direction (HTXRD) Analysis: Panalytical (PW3050/60) XRD with Co tube and Panalytical X'celerator detector was used to analyze changes in x-ray diffraction whith heated in-situ. Heated non-ambient chamber (Malvern HTK-1200N) inside the instrument. Co tube with Fe filter at 0.04 soller rad slit was used. All experiments were done at 0.02° step size with 60 s/step rate.

Small Angle X-Ray Scattering (SAXS) Analysis: The SAXS measurements were performed at the Xenocs Xeuss 2.0 UHR system. The Field's metal particles were placed between Kapton tapes in washers and then put in a sample holder inside the measurement chamber. The source was copper with radiation wavelength 0.154 nm. All the SAXS measurements were carried out at room temperature under vacuum.

Particle Synthesis. Field's Metal SLICE. Materials used include Field's metal, glacial acetic acid, ethyl acetate and diethylene glycol. 20 g of Field's metal was deposited in 1 vol % acetic acid-diethylene glycol solution (˜200 g) and heated up to 120° C. in a glass beaker of the soup maker (Cusinart SBC-1000FR). After thermal equilibrium reached in 5-7 min, the solution was sheared on a ˜10° angle for 4 min at about 17,000 rpm. Excess acetic acid-diethylene glycol solution was washed out with ethanol using Whatman GF/F filter using a Buchner filter and particles were stored in ethyl acetate solution after cleaning. BiSn SLICE: Materials used include eutectic BiSn metal, trichloroacetic acid, ethyl acetate and diethylene glycol. 10 g of BiSn was deposited in 1 vol % trichloroacetic acid-diethylene glycol solution (˜200 g) and heated up to 170° C. in a glass beaker. The solution was equilibrated at said temperature and then transferred to a preheated soup maker, wrapped in heating tape and aramid blanket (Cusinart SBC-1000FR). The solution was sheared on a ˜10° angle for 4 min at about 17,000 rpm. Excess trichloroacetic acid-diethylene glycol solution was washed out with ethanol using Whatman GF/F filter using a Buchner filter and particles were stored in ethyl acetate solution after cleaning. InSn SLICE: Materials used include InSn metal, glacial acetic acid, ethyl acetate and diethylene glycol. 10 g of InSn was deposited in 1 vol % acetic acid-diethylene glycol solution (˜200 g) and heated up to 150° C. in a glass beaker. The solution was equilibrated at said temperature and then transferred to a preheated soup maker, wrapped in heating tape and aramid blanket (Cusinart SBC-1000FR). The solution was sheared on a ˜10° angle for 4 min at about 17,000 rpm. Excess acetic acid-diethylene glycol solution was washed out with ethanol using Whatman GF/F filter using a Buchner filter and particles were stored in ethyl acetate solution after cleaning.

Calculation of volumetric change due to phase transition. Volumetric changes during phase transition was calculated using values in Table 1. Assuming 1 g of starting material, volumes of each elements were calculated in proportion for each alloy. AV for each element can then be calculated by taking Vₛₒₗ-V_{hiq}. Based on whether the material is contracting or expanding upon solidification, Contraction vs. expansion ratio (ΔV_{contract}/ΔV_{expand}) can be calculated to measure the amount of stress exerted during phase transition. For example, 1 g of Field's metal contain 0.51 g In, 0.325 g Bi and 0.165 g Sn. ΔV_{In} after liquid-solid phase transition is −2.8 mm³, whilst ΔV_{Sn}=−1.03 and ΔV_{Bi}=0.90. Taking a total of the contracting elements (In and Sn) and dividing it with the expanding element (Bi) gives a contraction-expansion ratio of 4.34. Same concept can be applied to BiSn where it yields a ratio of 1.83. No ratio is found for InSn due to the lack of expanding element.

TABLE 1
Material properties for elements forming the alloys

| | | Elastic | | |
|---|---|---|---|---|
| | Density | Modulus | Thermal Expansion | |
| Element | (g/cm³) | (GPa) | Coeff. (·10⁻⁶ K⁻¹) | E⁰ (V) |
| Indium (S) | 7.02 | 10 | 33 | −0.338 |
| Indium (L) | 7.31 | | | |
| Bismuth | 9.78 | 32 | 13.2 | 0.317 |
| (S) | | | | |
| Bismuth | 10.022 | | | |
| (L) | | | | |
| Tin (S) | 7.31 | 50 | 22 | −0.14 |
| Tin (L) | 6.99 | | | |

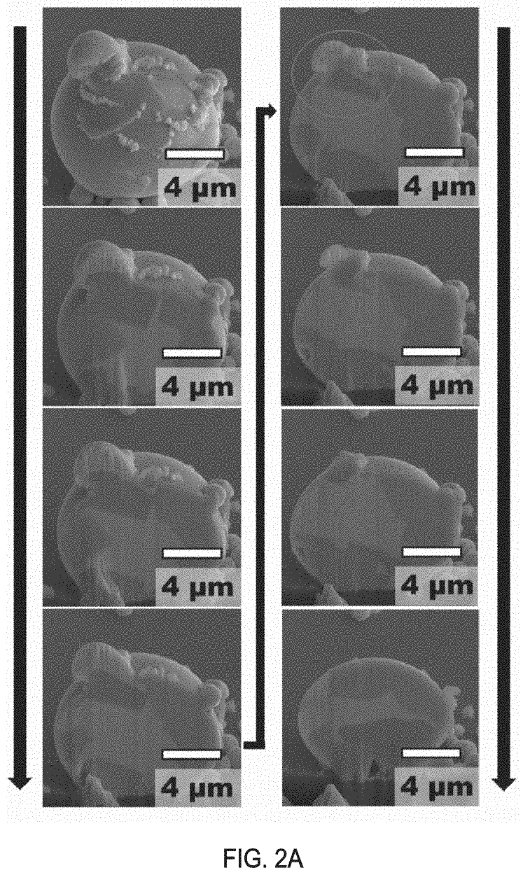

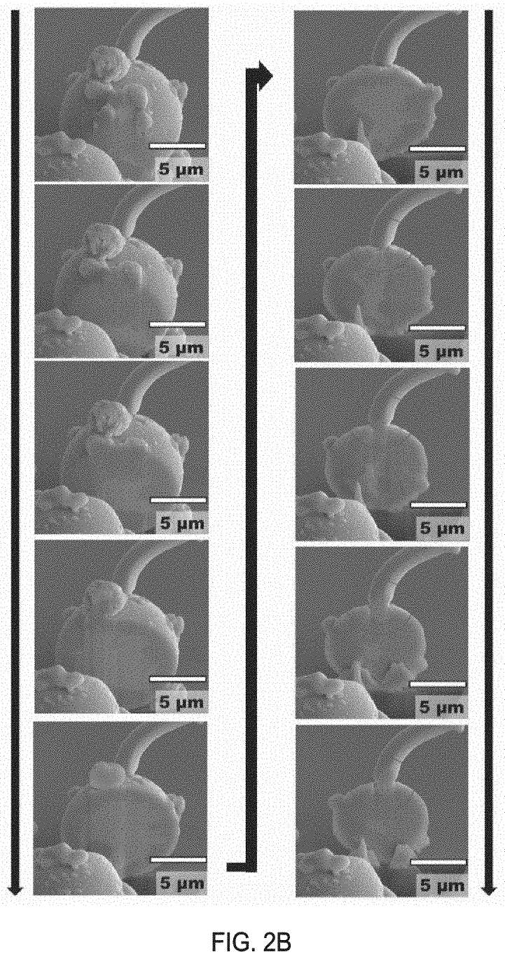

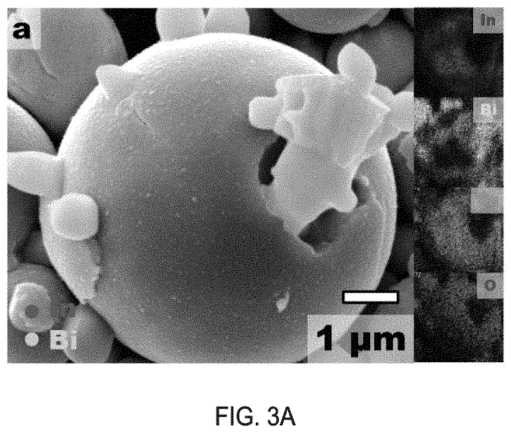

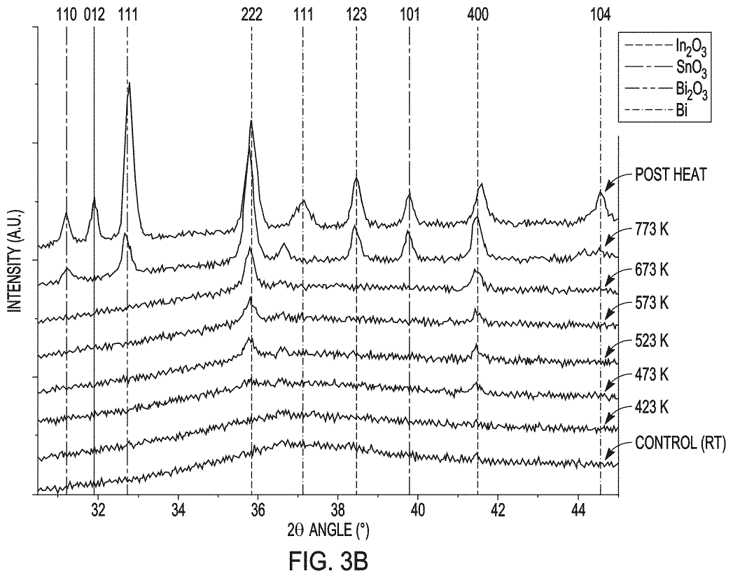

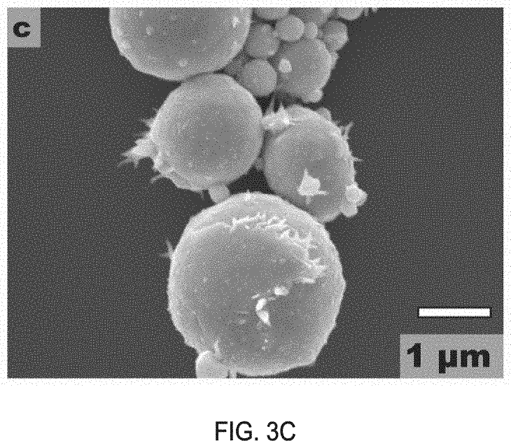

SAXS dimensional analysis background. The existence of a diffuse boundary is observed where there is a negative deviation from the ideal Porod's law constant (α=4) on the slope of the scattering intensity (Martin at FIG. 3c). The scattering vector q in these plots relates the scattering angle and the wavelength of the radiation used in this experiment (q=4π sin θ/λ), where θ is half the scattering angle and λ is the wavelength. The amount of deviation from the ideal exponent indicates that the electron density profile is not sharp, larger deviation can be suspected of thicker oxides. It can be seen that α increases as the particles are heated to 523 K (from −4.33 to −4.64), which indicates a growing oxide shell. The deviation, however, decreases as the particles reaches 773 K and even further to 1023 K, almost reaching the ideal value. We suspect that at 773 K, the oxide has reached a critical thickness to which it is no longer diffuse. This temperature also marks the emergence of the bismuth features (Martin at FIG. 2b), which suggests that fracturing already occurs, meaning the oxides already lose plasticity. As the particles are continually heated, these features will grow larger as the oxide also grows thicker (Martin at Figure S5c). At this point, the oxides would have formed larger crystalline structures that would no longer have a diffuse boundary with the bulk metal and thus the deviation disappears. Ruland's method was used to approximate the boundary thickness (Martin at Figure S7c), the plot was created based on the relationship: I(q)=Kₚ·q⁻⁴e^{(-σ}^{₂}^{q}^{₂}⁾, where σ (the slope in this plot) is the standard deviation of a gaussian smoothing function and Kₚ is the Porod's law constant, thickness of the oxide (t) can be calculated using the relationship: t=\sqrt{2πσ}. From Martin at FIG. 3d, it can be approximated that the fresh oxide of the ULMCS is about ˜7.3 nm and it can grow up to ˜9.6 nm at 523 K. At 773 K and beyond, the plot displays a straight horizontal line, which gives no approximation of oxide thickness. With this information, it is safe to assume that the oxide will continually grow while heated, upon reaching a critical point, the oxide will undergo crystallization and form the large features shown in Martin at FIG. 2.

### Discussion

Thin passivating surface oxide layers on metal alloys form a dissipation horizon between dissimilar phases, hence harbor an inherent free energy and composition gradient. We exploit this gradient to drive order and selective surface separation (speciation), enabling redox-driven enrichment of the core by selective conversion of low standard reduction potential (E^{O}) components into oxides. Coupling this oxide growth to volumetric changes during solidification allows us to create oxide crystallites trapped in a metal (‘ship-in-a-bottle’) or extrusion of metal fingerlings on the heavily oxidized particle. We confirm the underlying mechanism through high temperature X-ray diffraction and characterization of solidification-trapped particle states. We demonstrate that engineering the passivating surface oxide can lead to purification via selective dealloying with concomitant enrichment of the core, leading to disparate particle morphologies.

Passivating metal oxides are paradoxical entities in that they offer protection from corrosion—on condition that they do not spall or crack, but they deplete a metal (albeit minimally in most cases) and introduce interfaces with significantly different properties than the bulk. These oxides are a thermodynamically different entity from the bulk, yet at ambient are fixed component of the metal. Despite their small (nm) sizes, they have been utilized to stabilize metastable states or alter properties of liquid metals, leading to new unprecedented applications. Structural complexity in these nanoscale passivating oxide layers has, however, only been recently described albeit in liquid metals. Through felicitous choice of processing conditions, autonomous Thermal Oxidative Composition Inversion (TOCI) and surface texturing empirically confirmed this complexity and highlights underlying speciation (that is distribution and/or organization of alloy elements or mixed oxidation states) by externally exuding these gradients. By exploiting relation between mass and energy (E∝m), the composition gradient must lead to asymmetry in mass distribution hence a sharp energy gradient across the thin passivating layers. The energy gradient in turn can frustrate relaxation and equilibration leading to metastable material states. This ansatz has been demonstrated through stabilization of undercooled metal particles, that have enabled low-temperature metal processing. The inferences above, however, are premised on the outward growth of a thin (<20 nm) passivating oxide layer that is, Cabrera-Mott type oxidation, but speciation under thicker (>1 μm) oxide layers has not been demonstrated.

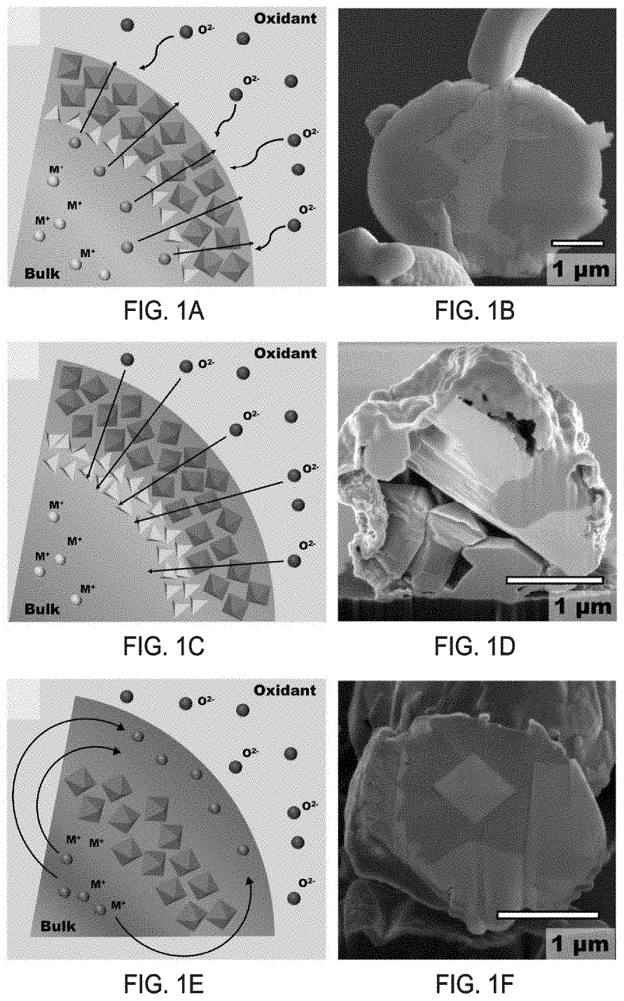

Surface oxidation of metals is mechanistically understood as a thickness-dependent asymmetric flux process in that, initially metal ions and/or electrons flux/migrate to the oxide-ambient surface and/or oxidant diffuses towards the oxide-metal interface. The former is well captured by the Cabrera-Mott oxidation theory (Martin at FIG. 1a) and, as expected, is limited to thin (<20 nm) oxide films. The latter dominates with thicker (>1 μm) oxides as described by the Wagner's oxidation theory (Martin at FIG. 1c). The intermediate region (20 nm<thickness<1 μm) has been captured as a rate-law differentiated transition regime (Xu-Rosso-Bruemmer postulate—abbreviated XRB postulate, Martin at FIG. 1b). The Cabrera-Mott and Wagner oxidation regimes follow an inverse logarithmic and a parabolic growth rate law respectively. The transition regime, however, follows a direct logarithmic growth rate. Factors that determine direction of ionic diffusion during the oxidation event have been shown to heavily depend on the potential and mobility differences between the metal cations (M⁺) and oxygen anions (O²⁻). Nature of atomic interactions, alloy composition, passivating oxide thickness and associated speciation, may also affect ionic diffusion. All these mechanisms, however, presume the existence of a native metal oxide film (Martin at FIGS. 1a-c). On a bare alloy surface, stoichiometry and stochasticity (equalling apriori probabilities for all alloy components to react) drive surface oxidation. This initial oxidation captures both composition and redox potential differences, setting up a surface speciation due to asymmetry in reactivity and diffusion (upon depletion of the topmost layer) that has not been captured until recently.

We inferred that the proposed asymmetric ionic and oxidant diffusion (Martin at FIGS. 1a-c) should manifest as perturbations to the metal-oxide interfaces. In an alloy system, however, differences in standard reduction potential (E^{O}) should induce a kinetically resolved differentiation and speciation. This differentiation in turn leads to concentration gradients across the oxide, with the surface being dominated by the most reactive component with concomitant enrichment of higher E^{O} component(s) at the metal-oxide interface. This ansatz, however, hinges on unrestricted diffusion of the alloy components—hence, the need for high plasticity at the metal-oxide interface. Liquid metals offer such an interface and are therefore ideal testbeds for this hypothesis. A caveat with liquid metals, however, is that surface plasticity and the fluidic state renders post speciation characterization challenging. Coupling this process to a phase change, however, arrests the metallic components in a form that cannot reconstitute post synthesis. Introducing a solidification step also allows one to capture physical changes due to negative (e.g. in Bi rich phases) or positive (e.g. Sn) thermal expansion. In the former, surface features akin to those observed during TOCI, but in non-oxidized form, are expected irrespective of the oxide thickness. In the latter, under the Wagner oxidation regime and extended oxide growth, entrapment of oxide crystallites inside metals is expected—akin to ‘ship-in-a-bottle’, as the metal solidifies around stalagmite/stalactite-like oxide protuberances. Depending on the orientation of the oxide crystallites relative to the molten component, the metal can solidify around the crystals leading to a tightly bound oxide-in-metal structure. With selective enrichment of the low E^{O} element into the oxide, hence dealloying, we infer that growing oxide crystallites can be engulfed by a metallic component rich in higher E^{O} component(s)—a feat that is otherwise impossible especially at the nano- to meso-scale. This speciation, however, hinges on the inward growth of the crystallites (Wagner regime) hence the oxide layer needs to be significantly thick. We infer that this will likely occur for alloys with significantly larger amounts of the lower E^{O} component. Beside growth kinetics, thermo-expansive work (thermal fatigue) initiated defects also affects resultant mass distribution, and uniform oxide growth.

Recent advances in the understanding of surface speciation during the oxidation process further suggest that the evolution of the surface oxide may lead to bulk or subsurface enrichment in the higher E^{O} component of the alloy. This autonomous speciation also manifests in the evolution in composition of surface oxides on liquid metal particles (Martin at FIG. 1d). We infer that this auto-speciation can lead to surface-driven de-alloying, hence changes in the bulk composition. In the case of negative thermal expansion core, the enriched component will stress and may break through the oxide shell on solidification, presenting metallic features on the surface—that is, an inversion in component distribution (Martin at FIG. 1f, top). Where phase change leads to contraction of the core, the oxide implodes (ductile shell) or cracks (brittle shell) trapping a metallic component (Martin at Figure if, bottom). Herein, we demonstrate these phase-change arrested configurations through felicitous choice of alloys and processing conditions.

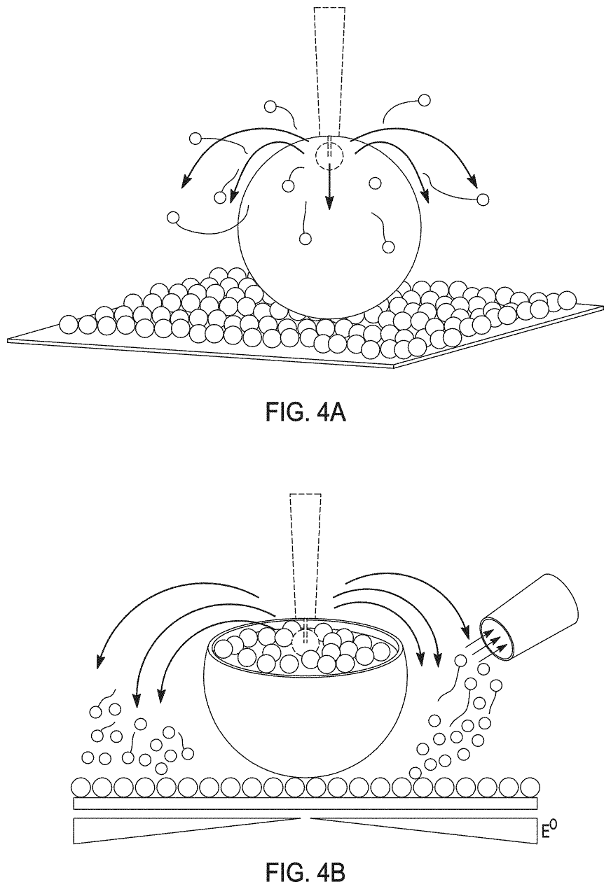

Negative Thermal Expansion (NTE). Field's metal (Bi: 32.5, In: 51, Sn: 16.5 wt %, or Bi: 21, In: 60.1, Sn: 18.8 at %, Tₘ=335 K) shows positive volumetric thermal expansion (+β, PTE), while Bi (highest E^{O} element) shows a negative thermal expansion (−β, NTE). We inferred that controlled dealloying by growth of the passivating oxidation deep into the Wagner regime, at T>Tₘ, would lead to In (E_{In}^{O}=−0.34, |βᵢₙ|=33·10⁻⁶ K⁻¹) and Sn (E_{Sn}^{O}=−0.14, |β_{Sn}|=22·10⁻⁶ K⁻¹) oxides with concomitant enrichment of Bi (E_{Sn}^{O}=0.32, |β_{Bi}|=13.2·10⁻⁶ K⁻¹) in the liquid core due to its comparatively higher positive E^{O} (Table 1). Compared to the commonly used gallium based liquid metals where the surface is highly dominated by the gallium oxide species (˜0.7-2 nm), undercooled Field's metal's oxide layer tends to be slightly thicker (˜4-5 nm), hence transition out of the Cabrera-Mott regime is likely to occur faster. Upon solidification, Bi expands while the oxides contract leading to exudates of solidifying Bi-rich phase (Martin at FIG. 1f, top). To illustrate this dealloying/purification, speciation, and solidification-driven inversion of component distribution, undercooled Field's metal particles were synthesized using the SLICE (Shearing Liquid Into Complex particlEs) method (see, I. D. Tevis, L. B. Newcomb and M. Thuo, Langmuir, 2014, 30, 14308-14313, hereby incorporated by reference in its entirety). The particles were ˜1.01+1.35 μm in diameter with solidification temperature of 224 K (Martin at Figure S1). These particles bear a thin (<5 nm) deformable oxide shell akin to oxidation in the Cabrera-Mott regime. For clarity, all particle images are false colored (see SI for non-colorized version) to highlight evolution in surface features. These particles were heated under low oxygen (≤10 ppm) over 573-1273 K range and samples were characterized at 100 K increments (Martin at Figure S2). For comparison, the particles were heated continuously at (10 K/min) to the target temperature with equilibration time, t_{c}, =0, 15, 30 or 45 mins (Martin at FIGS. 2 and S2). Deformation and cracks are observed when particles are heated to 573 K and tₑ=0 mins (Martin at FIG. 2a). The extent and distribution of these fractures is exacerbated for tₑ=30 mins (Martin at FIG. 2aᵢᵢ). These features are in part due to effect of thermal expansivity of a fragile oxide shell. We infer that thicker oxide shells would retain their shape and dissipate stress through cracks, fractures or spalling, increasing oxidant permeability or if core is liquidus and under tension, extrude underlying/bulk components as observed in TOCI. When particles were heated to 773 K and tₑ=0 mins, Bi rich surface features appear (Martin at FIG. 4bᵢ), suggesting that the core is rich in Bi. Formation of Bi-rich features is enhanced at t=30 mins (Martin at FIG. 2bᵢᵢ). Similarly, at T=873 K and tₑ=0 mins an increase in the number of Bi-rich surface features increases, while at T=873 K and tₑ=30 mins leads to increase in the size (length and/or width) of these surface features (Martin at FIGS. 2c and S2).

At 873 K and tₑ=30 mins, we observe that particles that evolve fewer surface features grow a dendrite-like structure (Martin at FIG. 2cᵢᵢ), confirming that these features emanate from stress dissipation from the bulk. Given that these features are rich in Bi, an NTE element, vindicates mismatch in thermal expansivity—and associated stresses in this evolution (Table 1). To confirm that these features are related to solidification and originate in the core, first, we sequentially sectioned a particle from the edge through the core (Martin at FIGS. 2e and S3). We observed that, as hypothesized, these features originate from or are connected to the core and are released to the surface via fissure-like paths (Martin at FIG. 2e). We infer that Bi is likely nucleating at the core and, during solidification, induces a solidification-driven mechanical tension due to phase change, σ_{PT}, leading to extrusion of the core with cooling and further solidification. Contraction of the oxide shell with cooling exacerbates σ_{PT} leading to fracture-driven stress dissipation. We infer that more Bi-rich exudates, albeit smaller in size, occur when multiple release points are formed on the oxide, otherwise the Bi features are larger when the release points are limited (conservation of matter). To confirm this inference, we sectioned two particles processed under the same conditions (T=873 K and tₑ=30 mins) but differing in the size, shape and number of surface features (Martin at Figure S3). We observe that irrespective of the morphology of the features, they originate from the core and are released via fissures forming across the oxide shell. In the absence of the surface features (T=573 K), however, a cross-section of the particle shows no centrally placed composition dissimilar feature (Martin at Figure S4). Similarly, when compared to a solid particle derived from the SLICE method, only expected spinodal patterns are observed (Martin at Figure S5) as previously observed. These control experiments support the inference that the observed features, speciation, and surface texture changes are not due to the particle preparation method but are due to increased oxidation and solidification of a liquid core.

Compositional mapping using Energy Dispersive x-ray Spectroscopy (EDS) reveals that the exudates are rich in Bi while the rest of the particle is rich in In—Sn. Low oxygen concentration in the exudates suggesting that they are likely metallic Bi that oxidizes upon extrusion (Martin at FIGS. 3a and S6). To closely understand these temperature dependent changes, we characterized the process using: i) coupled Differential Scanning Calorimetry-Thermogravimetric Analysis and InfraRed-Mass Spectrometry (DSC-TGA-IR-MS) and ii) High Temperature X-Ray Diffraction (HTXRD). The DSC-TGA-IR-MS captures mass and energy change with temperature while concomitantly characterizing volatile gases exudates by IR and MS, allowing us to compare the underlying process to the recently reported TOCI. Evolution in the identity and/or crystallinity of the surface oxide is captured via HTXRD. Minor (˜1.4%) and major (˜14.5%) exothermic mass gain events are observed at ca. 473 K and 773 K respectively (Martin at FIG. 3b). These events are analogous to previous patterns observed with other liquid metals. The minor peak at (˜450-550 K) leads to a spike in gaseous exudates as captured by the Gram-Schmidt plot (Martin at FIG. 3b). Since the minor peak corresponds to an MS spectrum dominated by m/z=44 amu (Martin at Figure S7a), we infer a likely loss of surface ligand with concomitant increase in oxide growth as previously observed. The major peak (˜600-800 K) is likely a continuous oxide growth as no volatile exudates are captured in the Gram Schmidt plot, MS, and IR spectra (Martin at Figures S7a-b). The mass increase plateaus at ˜800 K suggesting a change in the oxidation rate. Interestingly, these temperatures coincide with formation of cracks and Bi-rich surface features on the particles that are cooled back to ambient.

To confirm that the oxide shell is growing and playing a critical role, we estimate changes in thickness using Small-Angle X-ray Scattering (SAXS) dimensional analysis through Ruland's method. Existence of a diffuse boundary correlates with a negative deviation from ideal Porod's law constant (α=4), where a is the negative power of the scattering vector q, to which the scattered intensity I(q) is proportional (q^{-α}∝I(q)). These values are obtained through curve fitting and correspond to the slope of In I vs. In q (Martin at FIG. 3c). It can be seen that |α| increases as the particles are heated to 523 K (from 4.33 to 4.64), indicating a growing oxide shell. The deviation, however, decreases as the particles reaches 773 K and even further to 1023 K, almost reaching the ideal value. We infer that at 773 K, the oxide has reached a critical thickness upon which it is no longer diffuse or a second process (e.g., sintering or crystallization) counters any increase in thickness due to continued oxidation. Alternatively, the oxides likely form large crystalline structures (Wagner's regime) hence lack a diffuse boundary with the bulk metal hence no deviation in the scattering plot. Approximation of the boundary thickness was done using Ruland's method (Martin at Figure S7c) where it displays ˜7 nm thick passivating oxide shell at ambient that grows to ˜10 nm at 523 K. At 773 K and beyond, the plot displays a straight horizontal line, which gives no approximation of oxide thickness (oxide is too thick). We can therefore infer that at 773 K the oxidation is no longer in the Cabrera-Mott regime, but most likely transitioned to the Wagner regime, which is also indicated by the rapid mass growth between 600 and 800 K (Martin at FIG. 3b). Based on the mechanism of the Wagner regime, non-uniform growth of the oxide is likely as surface defects increases access of oxidant diffusion into the oxide-metal interface leading to loss of the diffuse interfacial boundary and localized accelerated growth of oxide crystallites. This inference would lead to stalagmite-stalactite like structures growing into the molten metal core with concomitant continued E^{O}-dependent dealloying as components oxidize and nucleate onto these crystallites. The interior of the particle, therefore, adopts a liquid-filled speleothem-like (cave-like) formation at high temperatures. Upon cooling, and solidification, the final structure depends on whether the core is an NTE or PTE component.

To further support this claim, we monitored oxide growth via in-situ HTXRD. Samples were heated at 10 K/min and analyzed at increments of 50 K—with the sample allowed to equilibrate for ˜20 minutes at each stage while the diffraction pattern is obtained. Using the as-prepared particles as a control, we monitored crystallization of the oxide shell. Fitting the emerging peaks to known oxides informed our inferences as to which component is crystalizing at what temperature (Martin at FIG. 3d). Obtained data complements TGA-IR-MS in that two transition points are observed during heating. The amorphous material shows no significant change in the diffraction patterns up to ˜523 K. For Field's metal, peaks aligning with In₂O₃ are the first to emerge, further supporting previous spectroscopic (auger and x-ray photo-electron)- and indirect empirical (TOCI)-based inferences on redox-driven surface speciation. These peaks continue to grow in intensity up to 773 K where SnO₂ peaks emerge. Similarly, these data agree with previous SEM, TGA-IR-MS-DSC and SAXS analysis. Alongside the SnO₂ formation at 773 K, a small peak associated with Bi₂O₃ is observed. Surprisingly, this peak further increases upon cooling the sample indicating continued growth of the bismuth oxide. This increased growth occurs alongside appearance of Bi (012, 111 and 104) peaks further suggesting that as Bi solidifies, it is being extruded which upon oxidation leads to enhanced Bi₂O₃ peaks. This data leads us to infer that the exudates are a consequence of solidification of an NTE component in a tightly closed shell. When the sample is cooled to room temperature all peaks experience a small shift due to thermal contraction. From the data above we confirm; i) selectivity in the formation of the oxide components correlates to redox potential (E_{In}^{O}=−0.34<E_{Sn}^{O}=−0.14<E_{Bi}^{O}=0.32) and not stoichiometrically (In>Bi>Sn) suggesting a redox-driven speciation/differentiation, ii) confirms TOCI, iii) a two-step oxidation process in the formation of the oxide shell, iv) the native oxide in Field's metal liquid particles is thin (<10 nm) but grows with heating, and v) the Bi surface features are extruded upon cooling with concomitant surface oxidation of the metal.

Based on the oxidation theories (Martin at FIGS. 1a-c) there is a possibility of creating an oxide shell in the Wagner regime where increase in oxidation does not lead to tight uniform growth on the inside due to localized growth of the oxide crystals. This would result in an oxide shell on the thermally expanded metal surface leading to an oxide shell that is larger than the solidified metal. In this case, there would be enough room for a solidifying NTE metal to remain in the now speleothem-like shell. Alternatively, enriching a higher E^{O} PTE component can lead to similar entrapment. In both cases, the molten metal would freely flow over stalagmite-like features and with solidification would create oxide-metal-oxide features. To illustrate this ansatz, we treated BiSn and InSn like the Field's metal and analyzed their core structures.

Furthermore, the chemical process of converting liquid metal to a solid through oxidation is well-understood. The process is diffusion-based for oxide metal layers of sufficient thickness, i.e., the Wagner regime. In this region the growth rate is proportional to an oxidizer concentration gradient across the oxide metal layer. Thus, the bulk liquid metal removal rate for the fastest oxidizing metal is proportional to the oxide layer growth rate and the oxidant concentration gradient, which decreases as the oxide layer grows. This may lead one to believe the fastest reacting metal oxide layer growth should be self-limiting as the concentration gradient reduces. Mass transport in the bulk liquid metal phase is, however, also diffusion-limited due to the small length scales (small liquid volumes) discussed in this study. Therefore, the oxide layer growth rate and bulk removal are coupled. A balance between a bulk planar diffusion process and the interface (solid-liquid) concentration based growth rate would suggest D ∂²c/∂x²=∂c/∂t (where D is fastest reacting bulk liquid metal diffusivity of concentration c) but with ∂c/∂t∝Δcₒₓ/x (where Δcoₓ is the ambient oxidizer concentration) the removal of fastest oxidizing metal from the bulk suggests a logarithmic flux i.e. ∂c/∂x ∝ ln x. Thus, the removal of the fastest oxidizing metal may be sustained throughout the growth process even when the identity of this species is changing with depletion of one alloy component. In light of this rate argument, sequential depletion of alloy components justifies the observed enrichment of the highest redox component in the bulk, allowing us to design a redox-based purification process.

Ship in a Bottle. Particles of BiSn (eutectic, Bi:Sn 58:42 wt %, or 44:56 at %, Tₘ=411 K) and InSn (eutectic, In:Sn 52:48 wt %, or 53:47 at %, Tₘ=391 K) were prepared using the SLICE method. The particles were undercooled to 264 K (BiSn) and 335 K (InSn) ensuring a liquidus phase far below temperatures of interest (Martin at Figure S1). For the BiSn samples, we observed that upon heating to 773 K the particles appeared wrinkled with minimal emergent surface texturing (Martin at FIG. 4a). Further heating to 873 K (Martin at FIG. 4b) or higher (Martin at Figure S8) increases wrinkling of the shell with analogous two-step transition events as with Field's metal, albeit at different temperatures (Martin at Figure S8e). Examining the cross-section of these particles reveals a trapped Bi-rich core albeit with significant void volume (Martin at FIGS. 4c, S9, and S10) suggesting that the observed wrinkling was due to thermal contraction. Unlike in ambient liquid metal particles that only develop a hollow core upon complete oxidation, the growth of crystallites, solidification, and concomitant separation/speciation triggers asymmetry in expansive work enabling formation of voids. Furthermore, BiSn contains high level of Bi (higher E^{O}) and thus depletion of the readily oxidizing component (Sn) is further enhanced, whilst Bi stays in the core. In this case, therefore, stoichiometry surpasses effect of thermal expansivity observed with Field's metal. Elemental analysis reveals the shell and growing crystallites to be predominantly SnO₂. To further confirm these changes, HTXRD analysis of the particles showed poor crystallinity in the as-synthesized BiSn particles with SnO/SnO₂ peaks becoming prominent at 773 K albeit with concomitant generation of yet to be assigned peaks (Martin at Figure S11a). As expected, diffraction peaks increase with continued heating. The enrichment indicates a clear separation/dealloying of the material with higher E^{O} (E_{Bi}^{O}=0.32, E_{Sn}^{O}=−0.14; ΔE^{O}=0.46) component isolating into the core. Interestingly, and as hypothesized, we observe entrapment of a growing oxide crystallite by the metal, which we infer are forming upon cooling (Martin at FIG. 4c). The observed engulfnent (Martin at FIG. 4c) shows a growing crystal that was partially encumbered by the metal, indicating that it is possible to fully encapsulate a growing crystallite inside a metal where the proportion of the metal/enriched core phase is high. This hypothesis is, however, limited by stoichiometry and requires almost equivalent proportions of the two elements in the binary alloy.

Comparatively, BiSn has 12% more of the lower E^{O} component and a large difference in redox potential (ΔE^{O}=0.46), while InSn presents a narrower redox gap (E_{In}^{O}=−0.32, E_{Sn}^{O}=−0.14, ΔE^{O}=0.18) and only a slight (6%) enrichment in the lower E^{O} component. In this case, we anticipate that surface oxidation in the Wagner regime would lead to significant growth of the dominant oxidizing species in the form of In₂O₃ crystallites and/or a thick oxide shell with Sn-rich phase trapped in the core. We observe that InSn particle show significant thermal stress spallation when heated to 773 k (Martin at FIG. 4d) and 873 K (Martin at FIGS. 4e, S12, and S13). Cross-section of these particles reveal a ‘ship-in-a-bottle’ in that the oxide is completely engulfed in the Sn-metal—an advanced stage of engulfment compared to that observed in BiSn. Elemental analysis by EDS (Martin at FIG. 4f) confirms the distribution of the components. Given that these particles undercool down to 335 K, XRD diffraction patterns of the control reveal presence of In, Sn and In₂O₃ with SnO/SnO₂ diffraction peaks only appearing after heat-treatment (Martin at FIG. S11b).

Conclusions. This work demonstrates the controlled behaviour of surface oxidation in metals and its potential in design of new particle structures or purification/dealloying. By tuning oxidation via temperature, oxidant partial pressure, time and composition, a balance between reactivity and thermal deformation enables unprecedented morphologies. By trapping these features through solidification, we can stabilize them below the materials melting point. (1) Metals undergo extended multi-step oxidation processes with temperature. These stages are; i) the stochastic stoichiometric oxidation stage to create the first pre-Cabrera-Mott film, ii) the Cabrera-Mott regime, iii) the intermediate XRB regime, and iv) Wagner regime. All these stages depend on amount of existing oxide film except for the statistical mechanics driven initial state when the bare metal surface is exposed to the oxidant. (2) Despite changing mechanisms, we exploit these processes to selectively induce dealloying leading to speciation into the growing oxide and concomitant purification/isolation of the highest E^{O} component to the core of the particle. Coupling the solidification to oxide growth leads to new particle morphologies analogous to macroscopic cave-formation (speleothem) albeit filled with the metal. (3) We paired oxidation rate laws to thermal expansivity to deploy alloy composition, stoichiometry and properties of the growing oxides to create dissimilar particle morphologies. For alloys where the NTE component has a significantly large ΔE^{O} difference to the most reactive components and is a minor component of the alloy (e.g. Field's metal), depletion of other elements allows for the extrusion of this component upon solidification. On the contrary, where the concentration of the NTE component is high, inward growth of the oxide may be insufficient to occupy all the space occupied by the expanded metal (e.g. in BiSn). In this case the metal solidifies onto the growing crystallites leading to ‘ship-in-a-bottle’ oxide-metal-oxide morphologies. (4) We also illustrate that although thermal expansivity is crucial, stoichiometric considerations may surpass asymmetry in volumetric changes as illustrated by Field's metal vs BiSn. A balance of total thermal expansive work is therefore essential in realizing the desired structures and/or morphologies.

### Example 2. Use of Heat/Oxidation, Shearing, or Laser Irradiation to Separate One or More Elements from an Alloy

As with the heating method described herein in Example 1, shearing and laser irradiation utilize differences in properties between elements to separate various elements from an alloy. Table 2 shows some of the constants that may be responsible for the separation.

TABLE 2

| | Shear | Standard | Absorption | |
|---|---|---|---|---|
| | Modulus, | Reduction | coeff, α | Polarizability |
| Elements | G (GPa) | Potential E⁰ (V) | (cm⁻¹) | (Å³) |
| In | 3 | −0.338 | 1.18 × 10⁶ | 2.62 |
| Sn | 14 | −0.14 | 1.09 × 10⁶ | 2.83 |
| Bi | 12 | 0.317 | 6.72 × 10⁵ | 6.12 |

For the heating process, the elements being separated are dependent on the standard reduction potential (E⁰). Lower E⁰ elements would tend to oxidize whilst the others doesn't, separating the alloyin an oxide/pure element system.

### Shearing.

For the shearing process, the SLICE method was used with a BiGaIn alloy. Under extended period of shearing, the most reactive element (e.g., In) is continually be depleted, removing the element into the shearing solvent and shifting the alloy composition.

The material was sheared for 10 minutes under a constant shear speed of 13000 rpm. Under an extended period of shearing, the most reactive component (In) was continually being depleted at a steady linear rate. Extreme shear speed also had an effect (at 17000 rpm) although it had a less significant effect than time, showing that this is a kinetic phenomena. Further proof of composition shifting was seen in a DSC plot as the melting point of the alloy with lower indium content had shifted by ˜20 degrees Celsius.

An EDS map of the sheared BiGaIn alloy showed a very discreet alloy separation of eutecticBiGaIn under shear stress. This process relies on the miscibility of the components making the alloy. Gallium and indium are very miscible and create a very low energy eutectic alloy (EGaIn) whilst bismuth is not very miscible with the two. Shearing this alloy gives enough kinetic energy for these elements to scramble and form their low energy states. The formed particles are very distinct from each other (as seen in the EDS Map, and also from the distinct melting points of each respective resulting alloy).

### Heat/Oxidation-Based Separation.

FIGS. 1A, 1C, and 1E illustrate schematics of various heat/oxidation-based separations. FIGS. 1B, 1D, and 1F illustrate SEM images of particles having been subjected to the heat/oxidation based separation shown in FIGS. 1A, 1C, and 1E, respectively. The color scheme applied to the SEM images of FIGS. 1B, 1D, and 1F correspond to the color scheme used in the schematics of FIGS. 1A, 1C, and 1E, respectively. In FIG. 1A, showing Field's metal (BiInSn eutectic alloy), the most reactive element responds to heat and forms a metal oxide on the surface. The least reactive elements stays dormant in the core and is released through mechanical fracturing due to heat expansion/contraction. In FIG. 1C, showing a BiSn alloy, when the oxide reaches a certain threshold, the kinetics of oxidation shifts to the core. This induces oxidation in the core whilst depleting the most reactive element, creating cavities with oxide crystals in the core. In FIG. 1E, showing an InSn alloy, when the most reactive elements within an alloy have competitive oxidation, the element with the lowest E⁰ oxidizes first, and upon cooling the non-reacted molten metal engulfs the formed oxide crystal, trapping the crystal in the core.

FIGS. 2A-B each illustrate a series of SEM images illustrating focused ion beam (FIB) milling of heat-treated Field's metal particles indicating the separation of the most reactive elements (darker contrast) and the least reactive component (lighter contrast) within the core of the particle. The thermal expansion contraction extruded some of the inner material through the formed cracks.

FIG. 3A illustrates an energy dispersive spectroscopy (EDS) map of the separation between the most reactive component forming the shell and the least reactive component coming out of the cracks due to thermal expansion-contraction of Field's metal particles. FIG. 3B illustrates an in-situ heated X-ray diffraction (XRD) pattern of a thermally treated Field's metal alloy displaying periodic growth of specific oxide, followed by crystallization (hence appearance of related x-ray signal) of the least reactive component post heating. FIG. 3C illustrates a SEM image of a heat-treated InSn alloy, showing that spallation may occur from excess oxidation, resulting in peeling of the outermost layer. FIG. 3A illustrates thermally treated Fields metal particles

### Laser Irradiation.

For the photon reaction, the reactivity is dependent on different factors.

Absorption coefficient defines how much light of a certain color is absorbed by the alloy. The higher numbers indicate that it will absorb higher wavelength colors (more red) and lower number indicate lower wavelength (more blue-purple). The reactivity of the electron configuration on certain elements depends on the polarizability. Elements such as bismuth and gold tend to have higher polarizability due to their tight electron configuration (lanthanide contraction, many overlapping accessible higher orbital states), thus under given photon energy supply, it is easier for these element to react.

In the method, the particles are irradiated with a laser to alter the oxidation profile of the metal elements in the alloy. In this case a higher E⁰ element, with accessible electronic transitions under applied light frequency, oxidizes first leading to its selective removal from the mixed metals as nanoparticle plumes. Then, the plumes are harvested to recover the oxidized species. The laser can be tuned to control which component gets oxidized (i.e., use a frequency that allows electronic transitions/excitation in a given metal). This renders that metal more susceptible to oxidation (that potential leads to surface diffusion and rapid oxidation). The lowest E⁰ component is left on the surface, since it is part of the native passivating oxide. By using a combination of thermally- and optically-driven separation, a target element can be selectively removed from an alloy mixture. FIGS. 4A and 4B illustrate schematics of a laser-based separation process. The grown particle is oversaturated and the most laser reactive element diffuses towards the surface, as shown in FIG. 4A. As shown in FIG. 4B, oversaturation leads to an explosion of the grown particle, and the energy released drives the distribution of plume toward the perimeter from the center of area-of-effect. The released plume is then harvested via a suction apparatus as shown in FIG. 4B.

A vacuum line can be used to suck away the plumes as they are generated. Only very low vacuum is needed (e.g., from 735 mmHg and below is the vacuum is about 1 cm from the surface of the metal. The vacuum can be applied using the tip of a Pasteur pipette to draw the plume into a tube on which a glass wool has been placed to trap the powder. Unless otherwise indicated, this is the plume-harvesting technique used in these Examples.

The further distance from the surface, the higher a vacuum power is needed. The vacuum stream can also be fed into a u-tube glass including appropriate filters or porous media to trap the particles. In another example, the vacuumed particles can be passed over a charged surface allowing the particles to be electrostatically trapped onto the walls of the charged surface. Where the surface is curved (e.g., a curved tube), the particles will also be separated by size with the largest particles sticking to the tube early and the smallest running the furthest. The harvested plumes can also be passed through a gas bubbler containing a solution of an appropriate ligand, e.g., oleylamine, that stabilizes the particles and limits sintering.

We have demonstrated the process with computer hard drives and NdB magnets. Initial studies with rare-earths (erbium and halfnium) shows that the pure elements readily convert to oxides in the form of plumes.

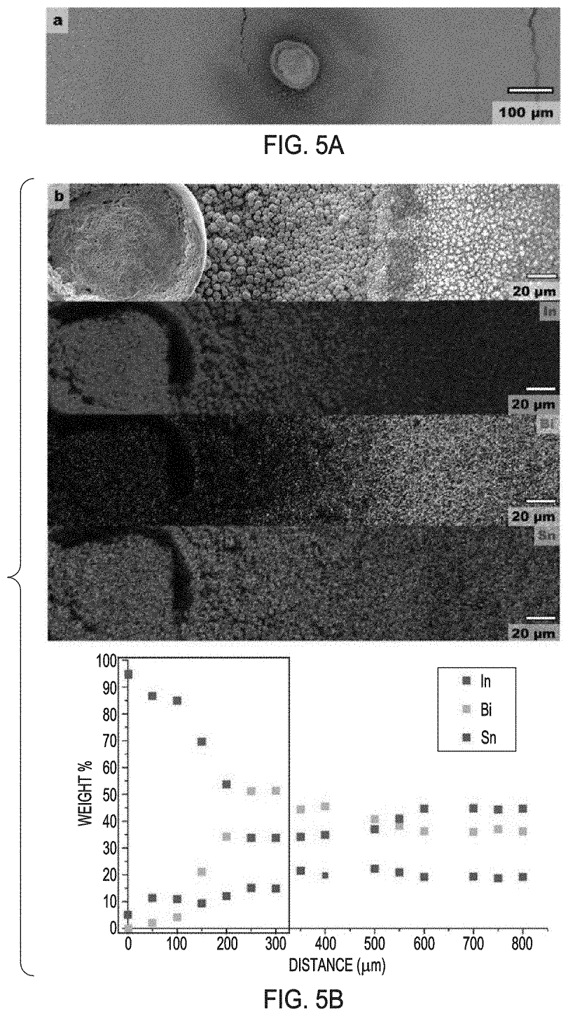

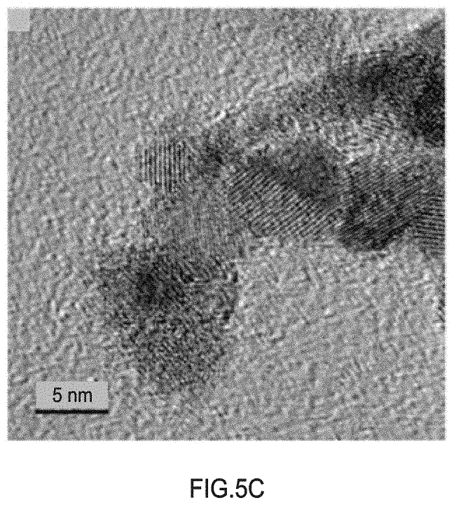

FIG. 5A illustrates a SEM image of a laser treated InBiSn particle, showing the overall area of effect with the exploded particle in the center and the generated plumes in the perimeter (cloudy fuzz-like material). FIG. 5B illustrates an energy dispersive spectroscopy (EDS) map of the area of effect shown in FIG. 5A, and a corresponding plot of weight percentage versus distance for each element, indicating the separation of the most laser-reactive element (least reactive with heat) towards the perimeter and the least laser reactive elements in the center. FIG. 5C illustrates a transmission electron microscopy (TEM) image of the harvested plume material, indicating crystallinity.

BiSn alloy. A plume-harvesting process was used to selectively obtain the enriched species (which can be dependent on the location at which the plumes are harvested). The obtained enriched Bi was in its oxide state and was a crystalline nanopowder.

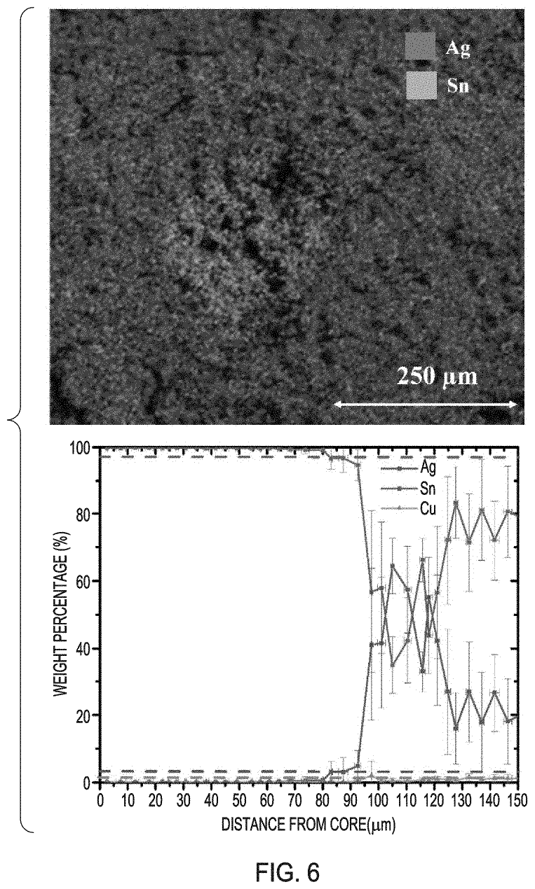

SAC305 (solder) alloy, having a composition of 96.5% Sn, 3% Ag, and 0.5% Cu. After the laser irradiation, the material left behind is pure tin oxide, showing that the laser has fully removed the Ag. FIG. 6 illustrates an EDS map of the area of effect after laser-treatment of SAC305 alloy, and a corresponding plot illustrating wt % versus distance from the core for the laser-treated SAC305 alloy.

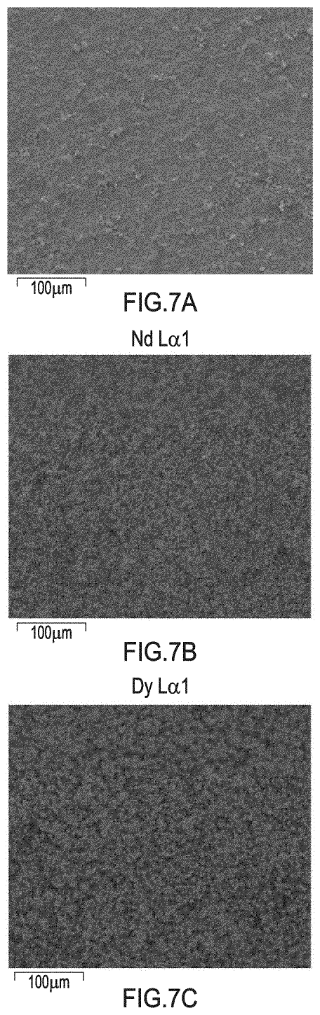

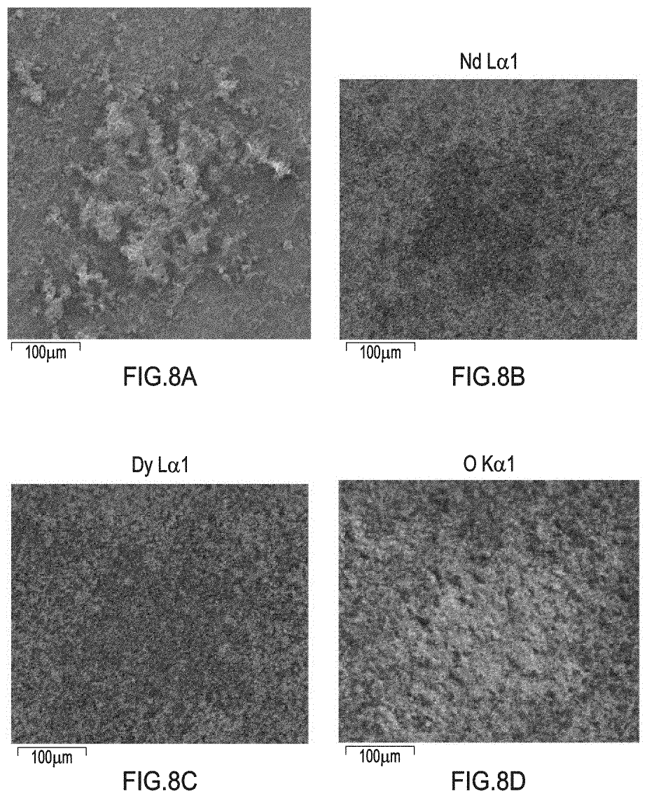

FIG. 7A illustrates a SEM image of an untreated Nd/Dy magnet recovered from a computer hard drive (i.e., e-waste). FIGS. 7B-C illustrates EDS maps of the untreated Nd/Dy magnet, with FIG. 7B showing Nd and FIG. 7C showing Dy. FIG. 8A illustrates a SEM image of the Nd/Dy magnet after laser-treatment. FIGS. 8B-D illustrate EDS maps of the treated Nd/Dy magnet, with FIG. 8B showing Nd, FIG. 8C showing Dy, and with FIG. 8D showing oxygen.

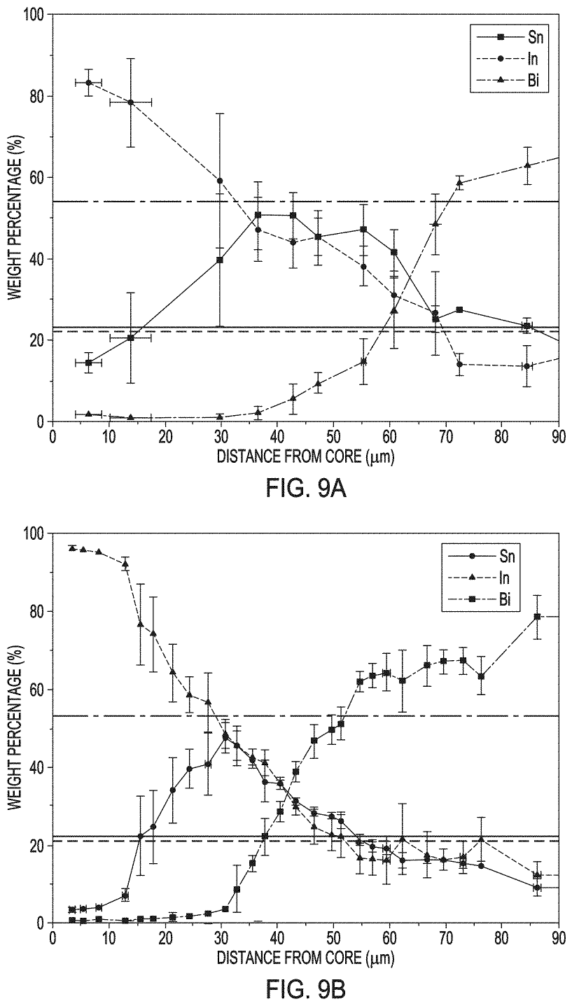

SnInBi alloy. FIG. 9A illustrates weight percent versus distance from the core for a laser-treated SnInBi alloy, using a 2.7 W blue laser for 30 s. FIG. 9B illustrates weight percent versus distance from the core for a laser-treated SnInBi alloy, using a 3.3 W blue laser for 30 s. The power quantifies amount of energy supplied to the system per second. More powder at the same exposure time means more energy of a particular wavelength supplied.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Exemplary Embodiments

The following exemplary embodiments are provided, the numbering of which is not to be construed as designating levels of importance:

Embodiment 1 provides a method of separating one or more elements from an alloy, the method comprising:
subjecting a metal alloy to a stimulus to form an enriched material comprising the one or more elements and to form a depleted material, wherein the enriched material is enriched in the one or more elements compared to the alloy and the depleted material is depleted in the one or more elements compared to the alloy; and
removing the enriched material and the depleted material from one another.

Embodiment 2 provides the method of Embodiment 1, wherein the stimulus comprises shear, laser irradiation, heat, or a combination thereof.

Embodiment 3 provides the method of any one of Embodiments 1-2, wherein the enriched material formed from subjecting the metal alloy to the stimulus is a solidified enriched material.

Embodiment 4 provides the method of any one of Embodiments 1-3, wherein the depleted material formed from subjecting the metal alloy to the stimulus is a solidified depleted material.

Embodiment 5 provides the method of any one of Embodiments 1-4, comprising removing the enriched material from the depleted material.

Embodiment 6 provides the method of any one of Embodiments 1-5, comprising removing the depleted material from the enriched material.

Embodiment 7 provides the method of any one of Embodiments 1-6, wherein the metal alloy comprises a liquid metal alloy.

Embodiment 8 provides the method of any one of Embodiments 1-7, wherein the metal alloy comprises a solid metal alloy.

Embodiment 9 provides the method of any one of Embodiments 1-8, wherein the metal alloy comprises a mixture of liquid metal alloy and solid metal alloy.

Embodiment 10 provides the method of any one of Embodiments 1-9, wherein a mixed material comprises the metal alloy.

Embodiment 11 provides the method of any one of Embodiments 1-10, wherein electronic waste comprises the metal alloy.

Embodiment 12 provides the method of any one of Embodiments 1-11, wherein a polymer composite comprises the metal alloy.

Embodiment 13 provides the method of any one of Embodiments 1-12, wherein a ceramic composite comprises the metal alloy.

Embodiment 14 provides the method of any one of Embodiments 1-13, wherein the metal alloy is magnetic.

Embodiment 15 provides the method of any one of Embodiments 1-14, wherein the enriched material formed from subjecting the metal alloy to the stimulus is a liquid enriched material, and/or the depleted material formed from subjecting the metal alloy to the stimulus is a liquid depleted material.

Embodiment 16 provides the method of Embodiment 15, further comprising solidifying the enriched material and/or the depleted material.

Embodiment 17 provides the method of Embodiment 16, wherein the solidifying comprises cooling the enriched material and/or the depleted material.

Embodiment 18 provides the method of any one of Embodiments 1-17, wherein the stimulus comprises shearing a mixture comprising the metal alloy in a solvent.

Embodiment 19 provides the method of any one of Embodiments 1-18, wherein the metal alloy comprises a solid metal oxide shell.

Embodiment 20 provides the method of any one of Embodiments 1-19, wherein the alloy comprises a solid core with a solid oxide shell, wherein the solid core comprises metal in a metastable solid state.

Embodiment 21 provides the method of any one of Embodiments 1-20, wherein the alloy comprises a solid core with a solid oxide shell, wherein the solid core comprises metallic glass.

Embodiment 22 provides the method of any one of Embodiments 1-21, wherein the method comprises laser irradiating the metal alloy.

Embodiment 23 provides the method of Embodiment 22, wherein the method comprises laser irradiating the metal alloy using a laser that is tuned to provide the greatest reactivity to the one or more elements in the alloy that the enriched material is enriched in compared to the depleted material.

Embodiment 24 provides the method of any one of Embodiments 1-23, wherein the stimulus comprises heating, wherein the heating comprises heating to 373 K to 2000 K.

Embodiment 25 provides the method of Embodiment 24, wherein the heating comprises heating to 750 K to 1500 K.

Embodiment 26 provides the method of any one of Embodiments 24-25, wherein the heating comprises heating for 0.1 min to 1 day.

Embodiment 27 provides the method of any one of Embodiments 24-26, wherein the heating comprises heating for 1 min to 2 h.

Embodiment 28 provides the method of any one of Embodiments 1-27, wherein the alloy comprises a liquid metallic core enclosed within a solid oxide shell.

Embodiment 29 provides the method of Embodiment 28, wherein the solid oxide shell has a diameter of 0.5 nm to 20 microns.

Embodiment 30 provides the method of any one of Embodiments 28-29, wherein the solid oxide shell has a diameter of 0.5 micron to 5 microns.

Embodiment 31 provides the method of any one of Embodiments 28-30, wherein during the subjecting of the alloy to the stimulus, the liquid alloy is below the melting point thereof.

Embodiment 32 provides the method of any one of Embodiments 28-31, wherein during the subjecting of the alloy to the stimulus, the liquid alloy is above the melting point thereof.

Embodiment 33 provides the method of any one of Embodiments 28-32, wherein the stimulus comprises laser irradiation, heat, or a combination thereof.

Embodiment 34 provides the method of any one of Embodiments 28-33, wherein the subjecting of the alloy to the stimulus causes preferential oxidation of elements in the alloy having the greatest reactivity toward oxidation.

Embodiment 35 provides the method of any one of Embodiments 28-34, wherein the subjecting of the alloy to the stimulus forms the enriched material on and/or outside an exterior of the shell.

Embodiment 36 provides the method of Embodiment 35, wherein the enriched material comprises a plume of enriched material extending from the shell.

Embodiment 37 provides the method of any one of Embodiments 28-36, wherein the subjecting of the alloy to the stimulus forms the enriched material in an interior of the shell.

Embodiment 38 provides the method of any one of Embodiments 28-37, wherein during the subjecting of the alloy to the stimulus, the shell grows in size and/or thickness, wherein the depleted material comprises the shell.

Embodiment 39 provides the method of any one of Embodiments 28-38, wherein the method comprises laser irradiating the shell of the core-shell particle.

Embodiment 40 provides the method of any one of Embodiments 28-39, wherein the method comprises laser irradiating the shell of the core-shell particle using a laser that is tuned to provide the greatest reactivity to the one or more elements in the alloy that the enriched material is enriched in compared to the depleted material.

Embodiment 41 provides the method of any one of Embodiments 28-40, wherein the stimulus includes heating the metal alloy, wherein the heating comprises heating to 373 K to 2000 K.

Embodiment 42 provides the method of Embodiment 41, wherein the heating comprises heating to 750 K to 1500 K.

Embodiment 43 provides the method of any one of Embodiments 41-42, wherein the heating comprises heating for 0.1 min to 1 day.

Embodiment 44 provides the method of any one of Embodiments 41-43, wherein the heating comprises heating for 1 min to 2 h.

Embodiment 45 provides the method of any one of Embodiments 1-44, wherein the removing comprises suction, blowing, chemical treatment, vibration, electrostatics, sink-float, density differentiation, centrifugal force, magnetic levitation, sonication, or a combination thereof.

Embodiment 46 provides the method of any one of Embodiments 1-45, wherein the alloy comprises Al, Fe, Cu, Zn, Ga, Ge, Ag, Cd, In, Sn, Sb, Te, Ho, Au, Pb, Bi, Nd, Fe, Sm, B, Er, Ni, Mn, Dy, Pr, W, Ti, Mg, Li, Co, or a combination thereof.

Embodiment 47 provides the method of any one of Embodiments 1-46, wherein the alloy comprises Bi, In, Sn, Ag, Au, Ga, Nd, B, Er, or a combination thereof.

Embodiment 48 provides the method of any one of Embodiments 1-47, wherein the alloy is a eutectic alloy.

Embodiment 49 provides the method of any one of Embodiments 1-48, wherein the alloy comprises Field's metal.

Embodiment 50 provides the method of any one of Embodiments 1-49, wherein the alloy comprises In and Sn.

Embodiment 51 provides the method of any one of Embodiments 1-50, wherein the alloy comprises Bi and Sn.

Embodiment 52 provides the method of any one of Embodiments 1-51, wherein the alloy comprises Bi, In, and Sn.

Embodiment 53 provides the method of any one of Embodiments 1-52, wherein the alloy comprises Bi, Ga, and In.

Embodiment 54 provides the method of any one of Embodiments 1-53, wherein the alloy comprises a solder alloy.

Embodiment 55 provides the method of any one of Embodiments 1-54, wherein the alloy comprises Sn, Ag, and Cu.

Embodiment 56 provides the method of any one of Embodiments 1-55, wherein the one or more elements comprise Al, Fe, Cu, Zn, Ga, Ge, Ag, Cd, In, Sn, Sb, Te, Ho, Au, Pb, Bi, Nd, Fe, Sm, B, Er, Ni, Mn, Dy, Pr, W, Ti, Mg, Li, Co, or a combination thereof.

Embodiment 57 provides the method of any one of Embodiments 1-56, wherein the enriched material is enriched in Al, Fe, Cu, Zn, Ga, Ge, Ag, Cd, In, Sn, Sb, Te, Ho, Au, Pb, Bi, Nd, Fe, Sm, B, Er, Ni, Mn, Dy, Pr, W, Ti, Mg, Li, Co, or a combination thereof, as compared to the alloy.

Embodiment 58 provides the method of any one of Embodiments 1-57, wherein 50 wt % to 100 wt % of the enriched material is the one or more elements.

Embodiment 59 provides the method of any one of Embodiments 1-58, wherein 80 wt % to 100 wt % of the enriched material is the one or more elements.

Embodiment 60 provides the method of any one of Embodiments 1-59, wherein 90 wt % to 100 wt % of the enriched material is the one or more elements.

Embodiment 61 provides the method of any one of Embodiments 1-60, wherein 0 wt % to 50 wt % of the depleted material is the one or more elements.

Embodiment 62 provides the method of any one of Embodiments 1-61, wherein 0 wt % to 20 wt % of the depleted material is the one or more elements.

Embodiment 63 provides the method of any one of Embodiments 1-62, wherein 0 wt % to 10 wt % of the depleted material is the one or more elements.

Embodiment 64 provides a method of separating one or more elements from an alloy, the method comprising:
subjecting a metal alloy to a stimulus comprising shearing a mixture comprising the alloy in a solvent to form an enriched material comprising the one or more elements and to form a depleted material, wherein the enriched material is enriched in the one or more elements compared to the alloy and the depleted material is depleted in the one or more elements compared to the alloy;
optionally solidifying the enriched material and/or the depleted material; and
removing the enriched material and the depleted material from one another;
wherein the one or more elements comprise Al, Fe, Cu, Zn, Ga, Ge, Ag, Cd, In, Sn, Sb, Te, Ho, Au, Pb, Bi, Nd, Fe, Sm, B, Er, Ni, Mn, Dy, Pr, W, Ti, Mg, Li, Co, or a combination thereof.

Embodiment 65 provides a method of separating one or more elements from an alloy, the method comprising:
subjecting a metal alloy to a stimulus comprising heating to form a solidified enriched material comprising the one or more elements and to form a solidified depleted material, wherein the enriched material is enriched in the one or more elements compared to the alloy and the depleted material is depleted in the one or more elements compared to the alloy; and
removing the solidified enriched material and the solidified depleted material from one another;
wherein the one or more elements comprise Al, Fe, Cu, Zn, Ga, Ge, Ag, Cd, In, Sn, Sb, Te, Ho, Au, Pb, Bi, Nd, Fe, Sm, B, Er, Ni, Mn, Dy, Pr, W, Ti, Mg, Li, Co, or a combination thereof.

Embodiment 66 provides a method of separating one or more elements from an alloy, the method comprising:
subjecting a metal alloy to a stimulus comprising laser irradiation to form a solidified enriched material comprising the one or more elements and to form a solidified depleted material, wherein the enriched material is enriched in the one or more elements compared to the alloy and the depleted material is depleted in the one or more elements compared to the alloy; and
removing the solidified enriched material and the solidified depleted material from one another;
wherein the one or more elements comprise Al, Fe, Cu, Zn, Ga, Ge, Ag, Cd, In, Sn, Sb, Te, Ho, Au, Pb, Bi, Nd, Fe, Sm, B, Er, Ni, Mn, Dy, Pr, W, Ti, Mg, Li, Co, or a combination thereof.

Embodiment 67 provides the method of any one or any combination of Embodiments 1-66 optionally configured such that all elements or options recited are available to use or select from.

What is claimed is:

1. A method of separating one or more elements from an alloy, the method comprising:
subjecting a metal alloy to a stimulus to form an enriched material comprising the one or more elements and to form a depleted material, wherein the enriched material is enriched in the one or more elements compared to the alloy and the depleted material is depleted in the one or more elements compared to the alloy; and
removing the enriched material and the depleted material from one another.

2. The method of claim 1, wherein the stimulus comprises shear, laser irradiation, heat, or a combination thereof.

3. The method of claim 1, wherein the metal alloy comprises a liquid metal alloy.

4. The method of claim 1, wherein the metal alloy comprises a solid metal alloy.

5. The method of claim 1, wherein a mixed material, electronic waste, a magnet, a polymer composite, and/or a ceramic composite comprises the metal alloy.

6. The method of claim 1, wherein the metal alloy is magnetic.

7. The method of claim 1, wherein the enriched material formed from subjecting the metal alloy to the stimulus is a liquid enriched material, and/or the depleted material formed from subjecting the metal alloy to the stimulus is a liquid depleted material, further comprising solidifying the enriched material and/or the depleted material.

8. The method of claim 1, wherein the metal alloy comprises a solid metal oxide shell.

9. The method of claim 8, wherein the solid oxide shell has a diameter of 0.5 nm to 20 microns.

10. The method of claim 8, wherein the subjecting of the alloy to the stimulus forms the enriched material on and/or outside an exterior of the shell.

11. The method of claim 8, wherein the subjecting of the alloy to the stimulus forms the enriched material in an interior of the shell.

12. The method of claim 1, wherein the alloy comprises a solid core with a solid oxide shell, wherein the solid core comprises metal in a metastable solid state.

13. The method of claim 1, wherein the alloy comprises a liquid metallic core enclosed within a solid oxide shell.

14. The method of claim 13, wherein during the subjecting of the alloy to the stimulus, the liquid alloy is below the melting point thereof.

15. The method of claim 1, wherein the stimulus comprises shearing a mixture comprising the metal alloy in a solvent.

16. The method of claim 1, wherein the method comprises laser irradiating the metal alloy.

17. The method of claim 1, wherein the stimulus comprises heating, wherein the heating comprises heating to 373 K to 2000 K.

18. The method of claim 1, wherein the removing comprises suction, blowing, chemical treatment, vibration, electrostatics, sink-float, density differentiation, centrifugal force, magnetic levitation, sonication, or a combination thereof.

19. The method of claim 1, wherein the metal alloy comprises:
a eutectic alloy,
Field's metal,
In and Sn,
Bi and Sn,
Bi, In, and Sn,
Bi, Ga, and In,
a solder alloy,
Sn, Ag, and Cu, or
a combination thereof.

20. A method of separating one or more elements from an alloy, the method comprising:
subjecting a metal alloy to a stimulus comprising heating and/or laser irradiation to form a solidified enriched material comprising the one or more elements and to form a solidified depleted material, wherein the enriched material is enriched in the one or more elements compared to the alloy and the depleted material is depleted in the one or more elements compared to the alloy; and
removing the solidified enriched material and the solidified depleted material from one another;
wherein the one or more elements comprise Al, Fe, Cu, Zn, Ga, Ge, Ag, Cd, In, Sn, Sb, Te, Ho, Au, Pb, Bi, Nd, Fe, Sm, B, Er, Ni, Mn, Dy, Pr, W, Ti, Mg, Li, Co, or a combination thereof.
